(19) United States
(12) Patent Application Publication
(10) Pub. No.: US 2015/0270562 A1
(43) Pub. Date: Sep. 24, 2015

(54) FUEL CELL VEHICLE

(71) Applicant: HONDA MOTOR CO., LTD., TOKYO (JP)

(72) Inventors: Hideharu NAITO, UTSUNOMIYA-SHI (JP); Takayuki NISHIYAMA, UTSUNOMIYA-SHI (JP); Mitsunori MATSUMOTO, UTSUNOMIYA-SHI (JP)

(21) Appl. No.: 14/661,197

(22) Filed: Mar. 18, 2015

(30) Foreign Application Priority Data
Mar. 20, 2014 (JP) 2014-057384
Feb. 12, 2015 (JP) 2015-025256

(51) Int. Cl. H01M 8/04; H01M 8/10; H01M 8/24

(52) U.S. Cl. CPC H01M 8/04201; H01M 8/24; H01M 8/1018; H01M 2250/20; H01M 2008/1095

(57) ABSTRACT

A stack case of a fuel cell vehicle contains a fuel cell stack, and the stack case is mounted in a front room. Openings are formed at one pair of diagonal positions of an upper panel forming an upper surface of the stack case. The inner space of the stack case is connected to the outside through the openings. Exhaust gas ducts connected to the openings are opened to the outside of the front room.

### CROSS-REFERENCE TO RELATED APPLICATIONS

This application is based upon and claims the benefit of priority from Japanese Patent Applications No. 2014-057384 filed on Mar. 20, 2014 and No. 2015-025256 filed on Feb. 12, 2015, the contents all of which are incorporated herein by reference.

### BACKGROUND OF THE INVENTION

1. Field of the Invention

The present invention relates to a fuel cell vehicle equipped with a fuel cell stack formed by stacking a plurality of fuel cells. The fuel cell stack is placed in a stack case, and the stack case is mounted in a front room formed in front of a dashboard.

2. Description of the Related Art

For example, a solid polymer electrolyte fuel cell employs a polymer ion exchange membrane as an electrolyte membrane, and the polymer electrolyte membrane is interposed between an anode and a cathode to form a membrane electrode assembly (MEA). The membrane electrode assembly and a pair of separators sandwiching the membrane electrode assembly make up a power generation cell for generating electricity. In use, typically, a predetermined number of the power generation cells are stacked together to form a fuel cell stack, e.g., mounted in a fuel cell vehicle.

In the fuel cell vehicle, in particular, hydrogen as a fuel gas may be leaked into a space for mounting the fuel cell stack. Therefore, in an attempt to efficiently discharge the hydrogen leaked from the fuel cell stack to the outside, for example, a fuel cell electric vehicle disclosed in Japanese Laid-Open Patent Publication No. 2004-040950 has been proposed.

In this fuel cell vehicle, a closed space for mounting a fuel cell is provided on the front side of the passenger compartment. Further, as necessary, a first opening is provided above the closed space, and a second opening is provided at a position where negative pressure is generated during traveling of the vehicle. Hydrogen leaked from the fuel cell system into the closed space is discharged through the first opening and the second opening.

According to the disclosure, in the case where the opening is provided above the closed space, in particular, when operation of the vehicle is stopped, the hydrogen leaked from the fuel system in the closed space can be ventilated to the outside of the vehicle reliably. Further, according to the disclosure, in the case where the opening is provided at the position where negative pressure is generated, the hydrogen leaked from the fuel cell system during traveling can be discharged from the closed space.

### SUMMARY OF THE INVENTION

In Japanese Laid-Open Patent Publication No. 2004-040950 described above, the opening is provided above the closed space. In the structure, when the vehicle is tilted toward the front or back side, or when the vehicle is tilted toward the left or right side, the hydrogen may be retained in the closed space undesirably. Therefore, leaked hydrogen cannot be ventilated to the outside of the vehicle reliably.

The present invention has been made to solve the problem of this type, and an object of the present invention is to provide a fuel cell vehicle having simple structure in which a fuel gas leaked into a stack case can be discharged to the outside easily and reliably.

A fuel cell vehicle according to the present invention is equipped with a fuel cell stack formed by stacking a plurality of fuel cells in a stacking direction. The fuel cells are configured to generate electricity by electrochemical reactions of a fuel gas and an oxygen-containing gas. A fuel gas passage extends through the fuel cells and is configured to allow the fuel gas to flow in the stacking direction. The fuel cell stack is placed in a stack case having a rectangular shape in a plan view. The stack case is mounted in a front room formed in front of a dashboard. Openings are formed at least at one pair of diagonal positions of an upper surface of the stack case, and an internal space of the stack case is connected to outside through the openings.

In the present invention, at least two openings are formed at diagonal positions of the upper surface of the stack case for connecting the internal space of the stack case to outside. In the structure, the fuel gas moving upward in the stack case is discharged from each of the openings.

Further, even if the vehicle is tilted in any direction, i.e., tilted toward the front or back side, or tilted toward the left or right side, the fuel gas can be discharged to the outside from at least one of the openings. Thus, with the simple structure, the fuel gas leaked into the stack case can be discharged to the outside easily and reliably.

The above and other objects, features and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a perspective view schematically showing a front portion of a fuel cell vehicle according to a first embodiment of the present invention;

FIG. 2 is a plan view schematically showing the fuel cell vehicle;

FIG. 3 is a front view schematically showing the fuel cell vehicle;

FIG. 4 is an exploded perspective view showing a stack case containing a fuel cell stack of the fuel cell vehicle;

FIG. 5 is an exploded perspective view showing main components of a fuel cell of the fuel cell stack;

FIG. 6 is a view showing a state where the back side of the fuel cell vehicle is tilted downward;

FIG. 7 is a view showing a state where the front side the fuel cell vehicle is tilted downward;

FIG. 8 is a perspective view schematically showing a front portion of a fuel cell vehicle according to a second embodiment of the present invention;

FIG. 9 is a perspective view schematically showing a front portion of a fuel cell vehicle according to a third embodiment of the present invention;

FIG. 10 is an exploded perspective view showing a stack case containing a fuel cell stack of the fuel cell vehicle;

FIG. 11 is a perspective view showing a bottom side of the stack case; and

FIG. 12 is a view showing air flows in the stack case.

### DESCRIPTION OF THE PREFERRED EMBODIMENTS

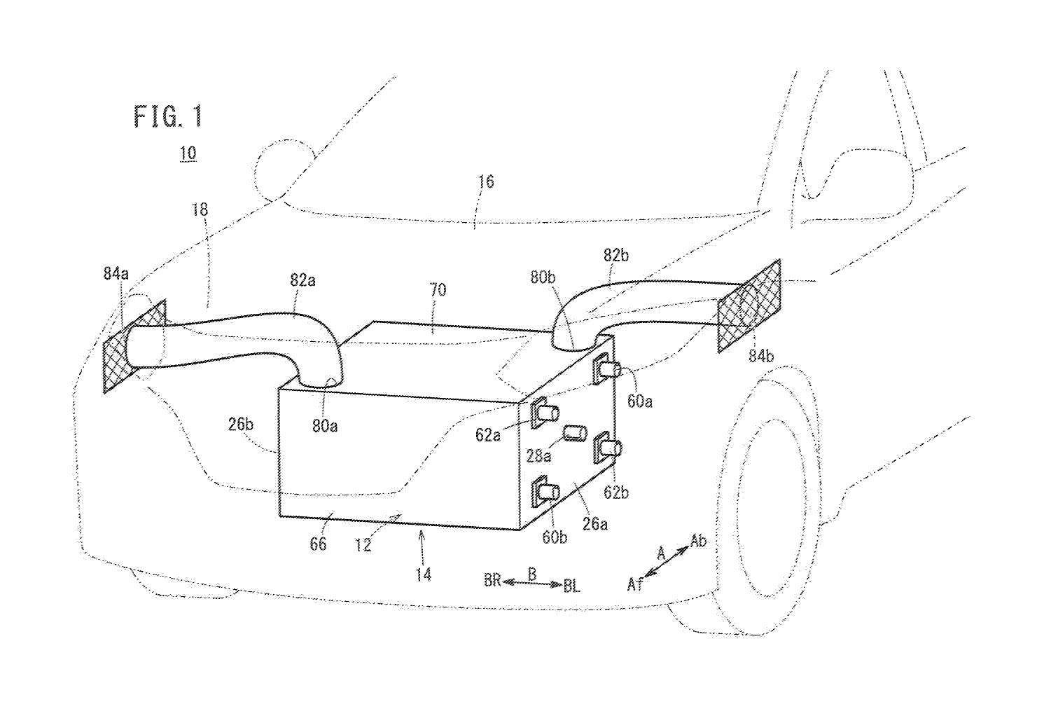

A fuel cell vehicle 10 according to a first embodiment of the present invention shown in FIGS. 1 to 3 is a fuel cell electric vehicle, for example. In the fuel cell vehicle 10, a stack case 14 containing a fuel cell stack 12 is provided in a front room (motor room) 18 provided in front of a dashboard 16.

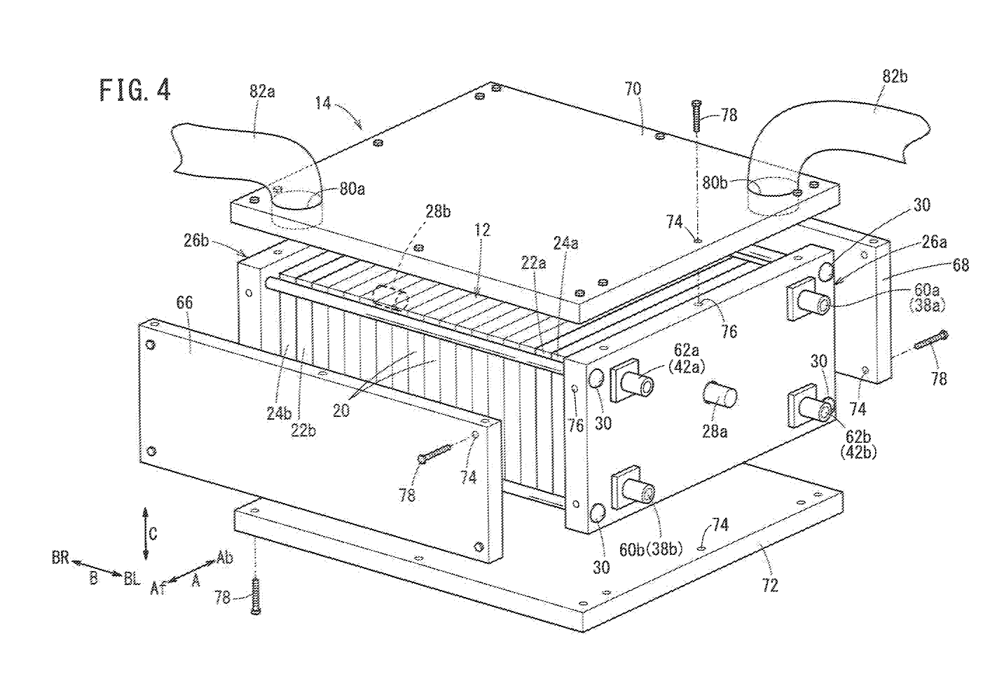

As shown in FIG. 4, the fuel cell stack 12 is formed by stacking a plurality of fuel cells 20 in a vehicle width direction indicated by an arrow B. At one end of the fuel cells 20 in the stacking direction, a first terminal plate 22a is provided. A first insulating plate 24a is provided outside the first terminal plate 22a, and a first end plate 26a is provided outside the first insulating plate 24a. At the other end of the fuel cells 20 in the stacking direction, a second terminal plate 22b is provided. A second insulating plate 24b is provided outside the second terminal plate 22b, and a second end plate 26b is provided outside the second insulating plate 24b. The first end plate 26a and the second end plate 26b are provided at both ends of the fuel cell stack 12 in the vehicle width direction.

The outer sizes of the first end plate 26a and the second end plate 26b are larger than the outer sizes of the fuel cells 20 and the first insulating plate 24a and the second insulating plate 24b. The first terminal plate 22a may be provided in a recess inside the first insulating plate 24a, and the second terminal plate 22b may be provided in a recess inside the second insulating plate 24b.

A first power output terminal 28a extends outward from a central position of the first end plate 26a having a laterally elongated shape. The first power output terminal 28a is connected to the first terminal plate 22a. A second power output terminal 28b extends outward from a central position of the second end plate 26b having a laterally elongated shape. The second power output terminal 28b is connected to the second terminal plate 22b. Corners of the first end plate 26a and the second end plate 26b are fixed by tie rods 30 extending in the stacking direction, and a tightening load is applied to components between the first end plate 26a and the second end plate 26b in the stacking direction.

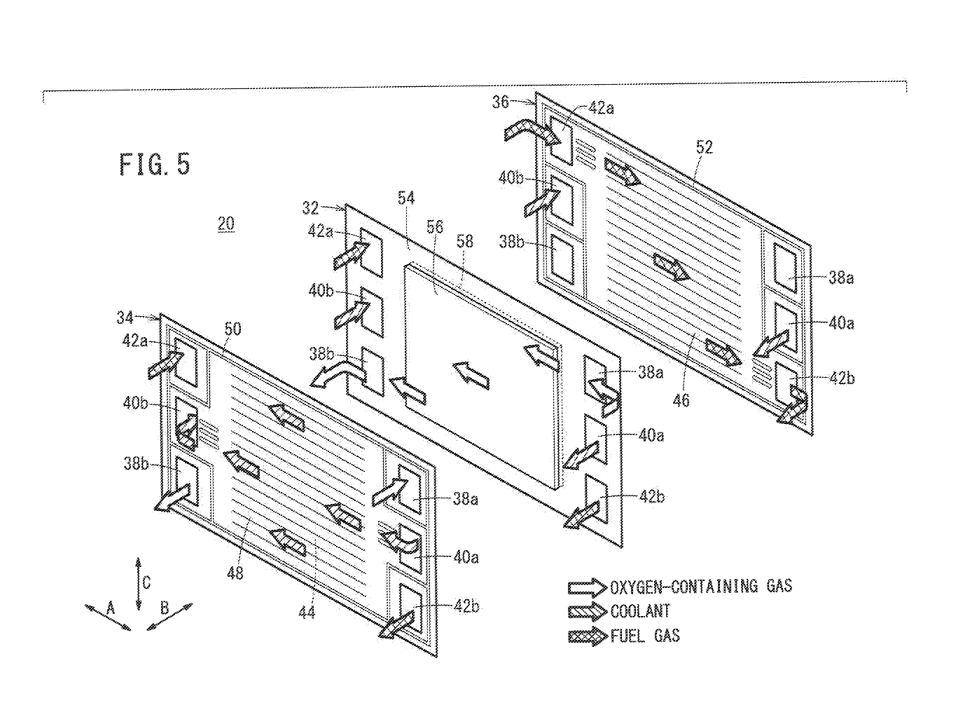

As shown in FIG. 5, the fuel cell 20 includes a membrane electrode assembly 32 and a first separator 34 and a second separator 36 sandwiching the membrane electrode assembly 32. The first separator 34 and the second separator 36 are metal separators or carbon separators.

At one end of the fuel cell 20 in the direction indicated by the arrow A, an oxygen-containing gas supply passage 38a, a coolant supply passage 40a, and a fuel gas discharge passage 42b are arranged in a vertical direction indicated by an arrow C. The oxygen-containing gas supply passage 38a, the coolant supply passage 40a, and the fuel gas discharge passage 42b extend through the fuel cell 20 in the direction indicated by the arrow B. An oxygen-containing gas is supplied through the oxygen-containing gas supply passage 38a. A coolant is supplied through the coolant supply passage 40a. A fuel gas such as a hydrogen-containing gas is discharged through the fuel gas discharge passage 42b.

At the other end of the fuel cell 20 in the direction indicated by the arrow A, a fuel gas supply passage 42a for supplying the fuel gas, a coolant discharge passage 40b for discharging the coolant, and an oxygen-containing gas discharge passage 38b for discharging the oxygen-containing gas are arranged in the direction indicated by the arrow C. The fuel gas supply passage 42a, the coolant discharge passage 40b, and the oxygen-containing gas discharge passage 38b extend through the fuel cell 20 in the direction indicated by the arrow B.

The first separator 34 has an oxygen-containing gas flow field 44 on its surface facing the membrane electrode assembly 32. The oxygen-containing gas flow field 44 is connected to the oxygen-containing gas supply passage 38a and the oxygen-containing gas discharge passage 38b. The second separator 36 has a fuel gas flow field 46 on its surface facing the membrane electrode assembly 32. The fuel gas flow field 46 is connected to the fuel gas supply passage 42a and the fuel gas discharge passage 42b.

A coolant flow field 48 is formed between the first separator 34 and the second separator 36 of the adjacent fuel cells 20. The coolant flow field 48 is connected to the coolant supply passage 40a and the coolant discharge passage 40b. Seal members 50, 52 are provided integrally with the first separator 34 and the second separator 36, respectively. Alternatively, members separate from the first separator 34 and the second separator 36 may be provided on the first separator 34 and the second separator 36, respectively.

The membrane electrode assembly 32 includes a cathode 56 and an anode 58, and a solid polymer electrolyte membrane 54 interposed between the cathode 56 and the anode 58. The solid polymer electrolyte membrane 54 is formed by impregnating a thin membrane of perfluorosulfonic acid with water, for example. Each of the cathode 56 and the anode 58 has a gas diffusion layer such as a carbon paper, and an electrode catalyst layer of platinum alloy supported on porous carbon particles. The carbon particles are deposited uniformly on the surface of the gas diffusion layer. The electrode catalyst layer of the cathode 56 and the electrode catalyst layer of the anode 58 are fixed to both surfaces of the solid polymer electrolyte membrane 54, respectively.

As shown in FIG. 4, an oxygen-containing gas supply manifold 60a and an oxygen-containing gas discharge manifold 60b are provided at one pair of diagonal positions of the first end plate 26a. The oxygen-containing gas supply manifold 60a is connected to the oxygen-containing gas supply passage 38a, and the oxygen-containing gas discharge manifold 60b is connected to the oxygen-containing gas discharge passage 38b. A fuel gas supply manifold 62a and a fuel gas discharge manifold 62b are provided at the other pair of diagonal positions of the first end plate 26a. The fuel gas supply manifold 62a is connected to the fuel gas supply passage 42a, and the fuel gas discharge manifold 62b is connected to the fuel gas discharge passage 42b.

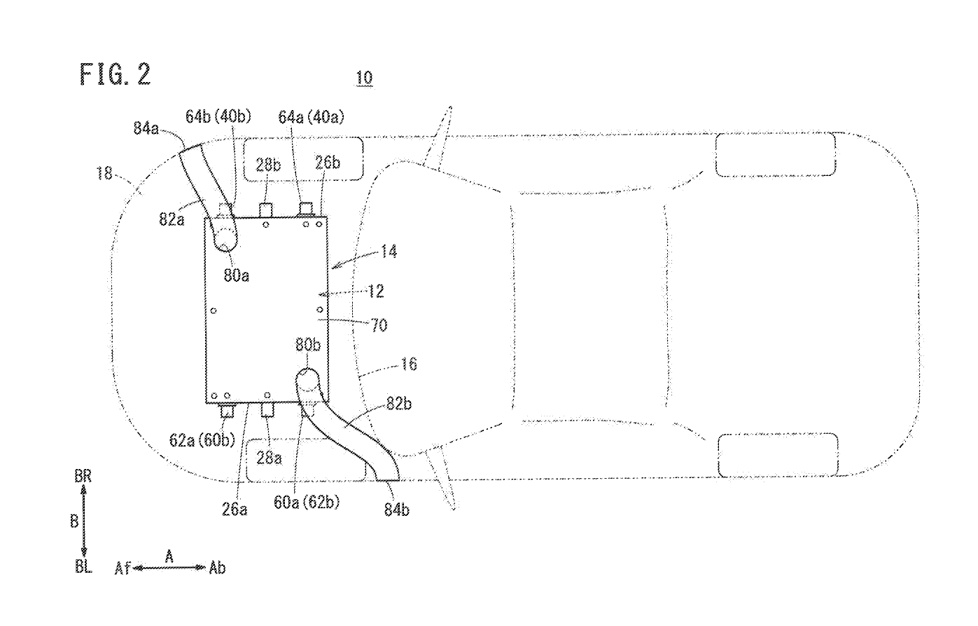

As shown in FIG. 2, a coolant supply manifold 64a and a coolant discharge manifold 64b are provided at the second end plate 26b. The coolant supply manifold 64a is connected to the coolant supply passage 40a, and the coolant discharge manifold 64b is connected to the coolant discharge passage 40b.

As shown in FIG. 4, the fuel cell stack 12 is placed in the stack case 14 having a rectangular shape, e.g., box shape in a plan view. The stack case 14 includes a front side panel 66, a rear side panel 68, an upper panel 70, a lower panel 72, the first end plate 26a, and the second end plate 26b. Components of the stack case 14 are fixed together, and fixed to the first end plate 26a and the second end plate 26b using screws 78 which are inserted into holes 74, and screwed into screw holes 76.

An inner surface of an upper panel 70 forming an upper surface of the stack case 14, i.e., a ceiling surface facing the fuel cell stack 12 is a flat surface. Openings 80a, 80b are formed at one pair of diagonal positions of the upper panel 70, and the internal space of the stack case 14 is connected to the outside through the openings 80a, 80b. The opening 80a is provided above the fuel gas supply passage 42a in the vertical direction.

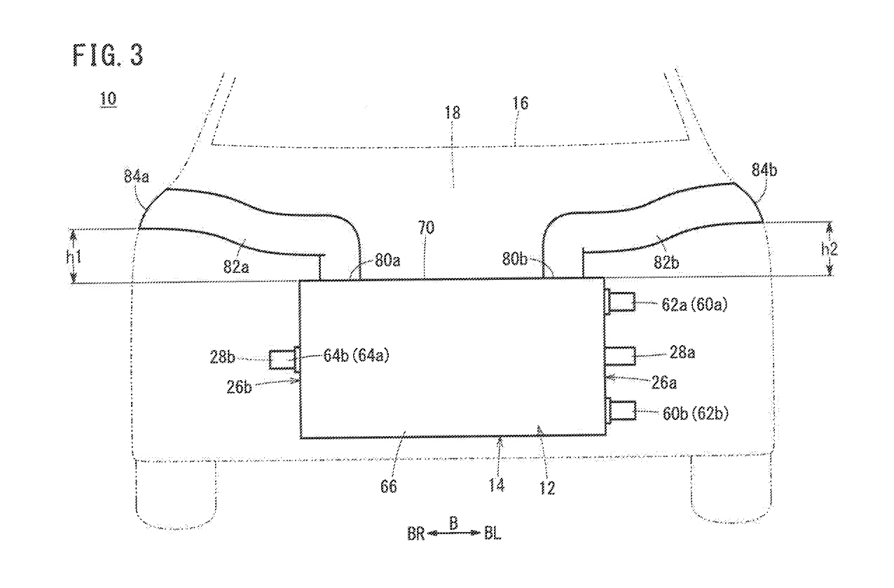

One end of an exhaust gas duct (duct member) 82a is connected to the opening 80a, and one end of an exhaust gas duct (duct member) 82b is connected to the opening 80b. As shown in FIGS. 1 to 3, the exhaust gas duct 82a protrudes upward from the stack case 14, and then, extends forward in a direction deviated from one vehicle width direction of the fuel cell vehicle 10 indicated by an arrow BR, and the exhaust gas duct 82a is connected to a front vehicle exhaust gas port (exhaust port) 84a formed on a side of the fuel cell vehicle 10. The front vehicle exhaust gas port 84a is opened to the outside of the front room 18, and as shown in FIG. 3, the front vehicle exhaust gas port 84a is spaced upward from the opening 80a of the stack case 14 by a distance h1.

The exhaust gas duct 82b protrudes upward from the stack case 14, and then, extends backward in a direction deviated from the other vehicle width direction indicated by an arrow BL, and the exhaust gas duct 82b is connected to a rear vehicle exhaust gas port (exhaust port) 84b formed on a side of the fuel cell vehicle 10. The rear vehicle exhaust gas port 84b is opened to the outside of the front room 18, and as shown in FIG. 3, the rear vehicle exhaust gas port 84b is spaced upward from the opening 80b of the stack case 14 by a distance h2. The fuel cell stack 12 is fixed to a vehicle frame using mount members (not shown) provided on the first end plate 26a and the second end plate 26b.

Operation of this fuel cell vehicle 10 will be described below.

Firstly, at the time of operating the fuel cell vehicle 10, as shown in FIG. 4, a fuel gas is supplied from the fuel gas supply manifold 62a at the first end plate 26a to the fuel gas supply passage 42a. In the meanwhile, an oxygen-containing gas is supplied from the oxygen-containing gas supply manifold 60a at the first end plate 26a to the oxygen-containing gas supply passage 38a.

As shown in FIG. 5, the fuel gas from the fuel gas supply passage 42a flows into the fuel gas flow field 46 of the second separator 36. The fuel gas (hydrogen gas) is supplied along the anode 58 of the membrane electrode assembly 32 for inducing an electrochemical reaction at the anode 58.

The oxygen-containing gas from the oxygen-containing gas supply passage 38a flows into the oxygen-containing gas flow field 44 of the first separator 34. The oxygen-containing gas is supplied along the cathode 56 of the membrane electrode assembly 32 for inducing an electrochemical reaction at the cathode 56.

Thus, in the membrane electrode assembly 32, the hydrogen gas supplied to the anode 58 and the air supplied to the cathode 56 are partially consumed in the electrochemical reactions at catalyst layers of the anode 58 and the cathode 56 for generating electricity.

As shown in FIG. 4, the fuel gas is discharged from the fuel gas discharge passage 42b to the fuel gas discharge manifold 62b at the first end plate 26a. The oxygen-containing gas is discharged from the oxygen-containing gas discharge passage 38b to the oxygen-containing gas discharge manifold 60b at the first end plate 26a.

Further, as shown in FIG. 2, the coolant is supplied from the coolant supply manifold 64a at the second end plate 26b to the coolant supply passage 40a. As shown in FIG. 5, the coolant flows into the coolant flow field 48 between the first separator 34 and the second separator 36. After the coolant cools the membrane electrode assembly 32, the coolant flows through the coolant discharge passage 40b, and the coolant is discharged to the coolant discharge manifold 64b.

In the first embodiment, the two openings 80a, 80b are formed at diagonal positions of the upper panel 70 as the upper surface of the stack case 14. The openings 80a, 80b connect the internal space of the stack case 14 to the outside. One end of the exhaust gas duct 82a is connected to the opening 80a, and one end of the exhaust gas duct 82b is connected to the opening 80b. The other end of the exhaust gas duct 82a and the other end of the exhaust gas duct 82b are opened to the outside through the front vehicle exhaust gas port 84a and the rear vehicle exhaust gas port 84b which are spaced upward from the stack case 14.

In the structure, since the fuel gas leaked from the fuel cell stack 12, such as the hydrogen, is lighter than the air, the fuel gas moves up inside the stack case 14, and then, the fuel gas is discharged from the openings 80a, 80b. Consequently, the fuel gas is not retained inside the stack case 14.

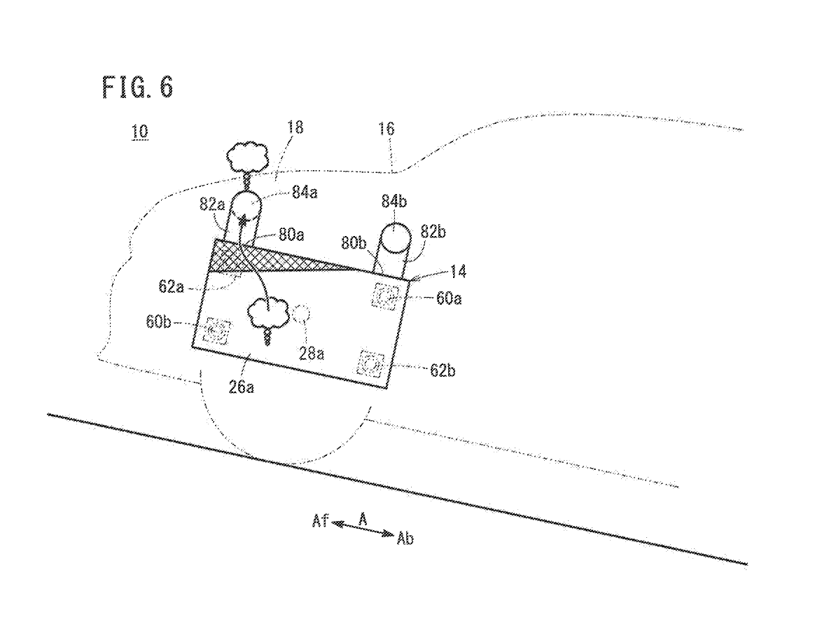

Further, as shown in FIG. 6, in some cases, the back side of the fuel cell vehicle 10 is tilted downward. In this situation, the fuel gas inside the stack case 14 moves forward and upward in the stack case 14, and the fuel gas is discharged reliably to the outside from the opening 80a through the exhaust gas duct 82a and the front vehicle exhaust gas port 84a.

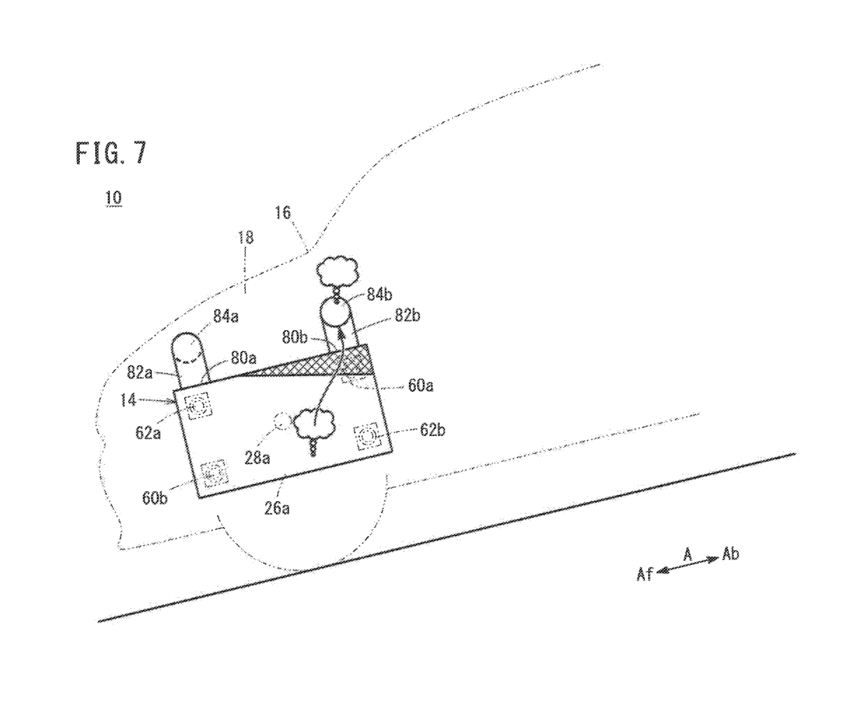

Further, as shown in FIG. 7, in some cases, the front side of the fuel cell vehicle 10 is tilted downward. In this situation, the fuel gas inside the stack case 14 moves backward and upward in the stack case 14, and the fuel gas is discharged reliably to the outside from the opening 80b through the exhaust gas duct 82b and the rear vehicle exhaust gas port 84b.

Further, in the case where the right side of the fuel cell vehicle 10 in the direction indicated by the arrow BR is tilted downward, the fuel gas in the stack case 14 is discharged smoothly from the opening 80b to the outside. In the case where the left side of the fuel cell vehicle 10 in the direction indicated by the arrow BL is tilted downward, the fuel gas in the stack case 14 is discharged smoothly from the opening 80a to the outside.

Accordingly, even if the fuel cell vehicle 10 is tilted in any direction, i.e., tilted toward the front or back side, or tilted toward the left or right side, the fuel gas can be discharged to the outside from at least one of the opening 80a and the opening 80b. Thus, with the simple structure, the fuel gas leaked into the stack case 14 can be discharged to the outside easily and reliably.

Further, the inner surface of the upper panel 70 forming the upper surface of the stack case 14, i.e., the ceiling surface facing the fuel cell stack 12 is a flat surface. Therefore, the fuel gas moving upward in the stack case 14 flows toward the opening 80a or the opening 80b smoothly. Thus, improvement in the performance of discharging the fuel gas from the stack case 14 to the outside is achieved suitably.

Moreover, the opening 80a is provided above the fuel gas supply passage 42a in the vertical direction. Accordingly, in particular, the fuel gas leaked from the fuel gas supply passage 42a can be discharged to the outside through the opening 80a easily and reliably.

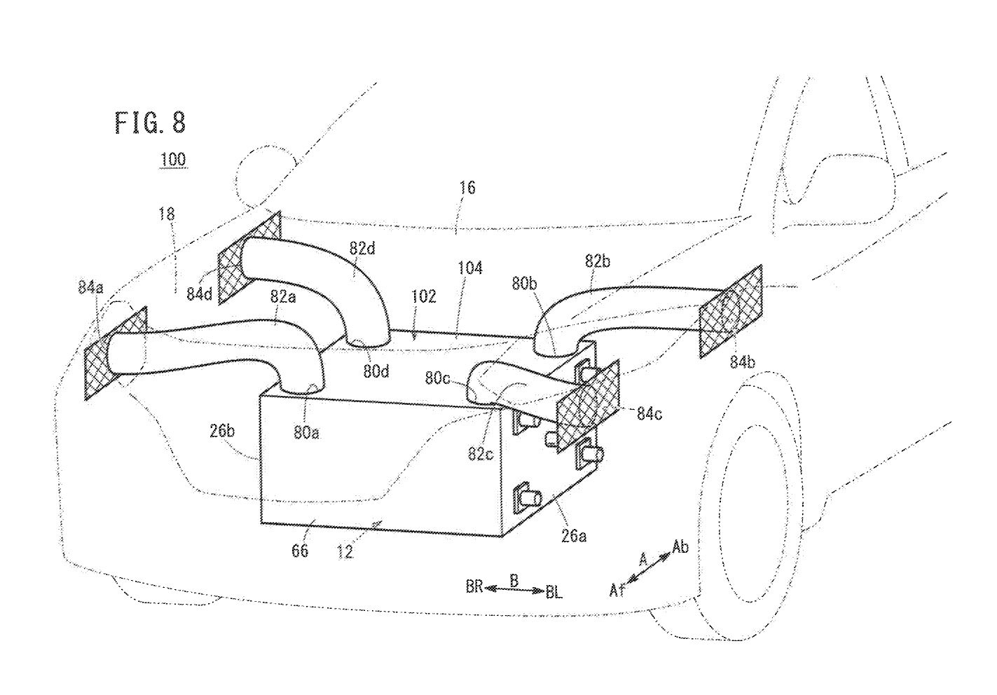

FIG. 8 is a perspective view schematically showing a front portion of a fuel cell vehicle 100 according to a second embodiment of the present invention. The constituent elements of the fuel cell vehicle 100 that are identical to those of the fuel cell vehicle 10 according to the first embodiment are labeled with the same reference numerals, and detailed description thereof is omitted.

The fuel cell vehicle 100 includes a stack case 102 containing the fuel cell stack 12. The stack case 102 includes an upper panel 104, and the upper panel 104 forms an upper surface of the stack case 102.

Openings 80a, 80b are formed at one pair of diagonal positions of the upper panel 104, and the internal space of the stack case 102 is connected to the outside through the openings 80a, 80b. Openings 80c, 80d are formed at the other pair of diagonal positions of the upper panel 104, and the internal space of the stack case 102 is connected to the outside through the openings 80c, 80d. The openings 80a, 80c are provided on the front side of the stack case 102, at both ends in the vehicle width direction, above the fuel gas supply passage 42a in the vertical direction. The openings 80b, 80d are provided on the back side of the stack case 102, at both ends in the vehicle width direction.

One end of an exhaust gas duct (duct member) 82c is connected to the opening 80c, and one end of an exhaust gas duct (duct member) 82d is connected to the opening 80d. The exhaust gas duct 82c protrudes upward from the stack case 102, and then, the exhaust gas duct 82c extends forward in a direction deviated from the other vehicle width direction of the fuel cell vehicle 100 indicated by an arrow BL, and the exhaust gas duct 82d is connected to a front vehicle exhaust gas port 84c formed on a side of the fuel cell vehicle 100. The front vehicle exhaust gas port 84c is opened to the outside of the front room 18, and spaced upward from the opening 80c of the stack case 102.

The exhaust gas duct 82d protrudes upward from the stack case 102, and then, the exhaust gas duct 82d extends backward in a direction deviated from one vehicle width direction of the fuel cell vehicle 100 indicated by an arrow BR, and the exhaust gas duct 82d is connected to a rear vehicle exhaust gas port 84d on a side of the fuel cell vehicle 100. The rear vehicle exhaust gas port 84d is opened to the outside of the front room 18, and spaced upward from the opening 80d of the stack case 102.

In the second embodiment, the four openings 80a to 80d are formed at the two pairs of diagonal positions of the upper panel 104 forming the upper surface of the stack case 102. The internal space of the stack case 102 is connected to the outside through the openings 80a to 80d. One ends of the exhaust gas ducts 82a to 82d are connected to the openings 80a to 80d, and the other ends of the exhaust gas ducts 82a to 82d are opened to the outside.

Accordingly, even if the fuel cell vehicle 100 is tilted in any direction, i.e., tilted toward the front or back side, or tilted toward the left or right side, the fuel gas can be discharged to the outside from at least one of the opening 80a to 80d. Thus, the same advantages as in the case of the first embodiment are obtained. For example, with the simple structure, the fuel gas leaked into the stack case 102 can be discharged to the outside easily and reliably.

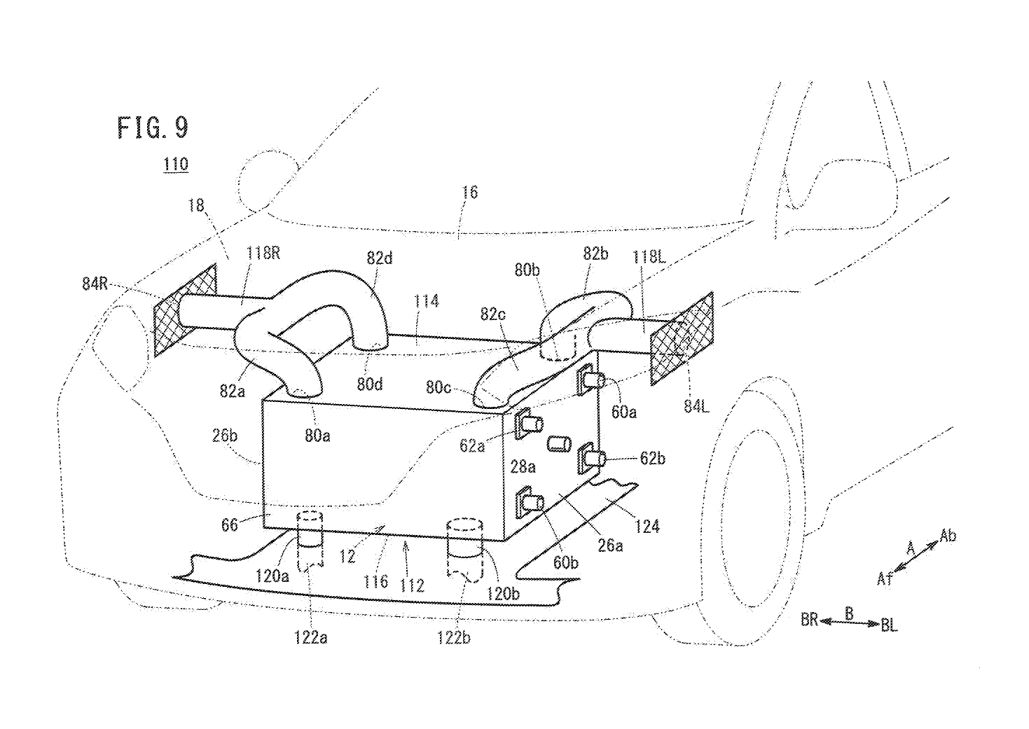

FIG. 9 is a perspective view schematically showing a front portion of a fuel cell vehicle 110 according to a third embodiment of the present invention. The constituent elements of the fuel cell vehicle 100 that are identical to those of the fuel cell vehicles 10, 100 according to the first and second embodiments are labeled with the same reference numerals, and detailed description thereof is omitted.

The fuel cell vehicle 110 includes a stack case 112 containing the fuel cell stack 12. As shown in FIGS. 9 to 11, the stack case 112 includes an upper panel 114 and a lower panel 116. The upper panel 114 forms an upper surface of the stack case 112, and the lower panel 116 forms a lower surface of the stack case 112.

As shown in FIG. 9, one ends of exhaust gas ducts 82a to 82d are connected to the upper panel 114. The other end of the exhaust gas duct 82a and the other end of the exhaust gas duct 82d are merged, and connected to a right exhaust gas duct 118R. The right exhaust gas duct 118R is connected to a vehicle exhaust gas port 84R. The other end of the exhaust gas duct 82b and the other end of the exhaust gas duct 82c are merged, and connected to a left exhaust gas duct 118L. The left exhaust gas duct 118L is connected to a vehicle exhaust gas port 84L.

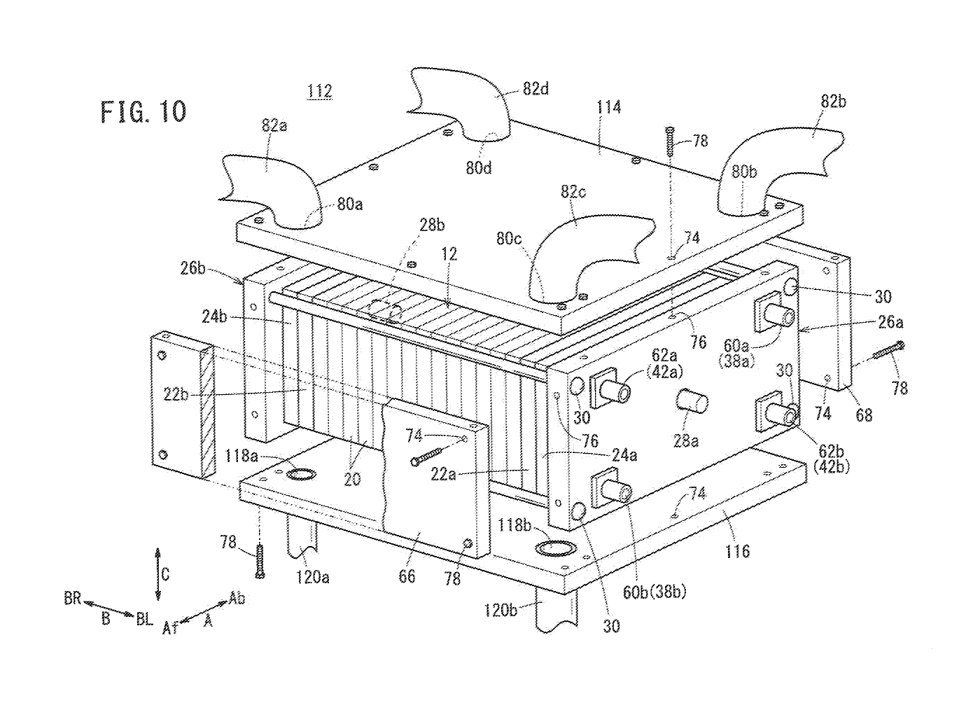

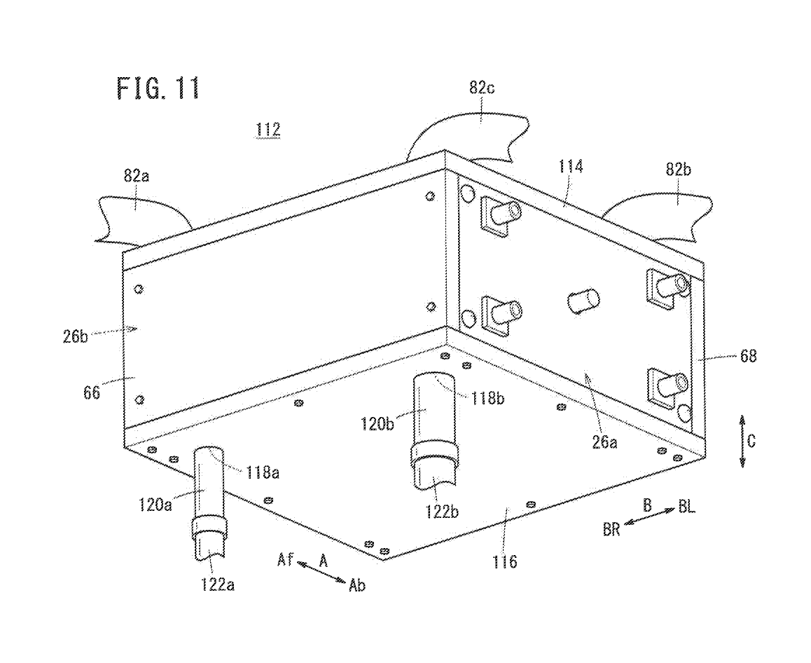

As shown in FIGS. 10 and 11, the lower panel 116 has two (or three or more) air intake openings 118a, 118b on the vehicle front side. The air intake openings 118a, 118b are opened to the internal space of the stack case 112, and provided at positions deviated forward or backward from a position immediately below a tie rod (or tightening bar) 30. The diameter of the air intake opening 118b adjacent to the first end plate 26a, i.e., adjacent to the fuel gas supply manifold 62a and the fuel gas discharge manifold 62b is larger than the diameter of the air intake opening 118a adjacent to the second end plate 26b. It is because the volume of the leaked fuel gas tends to be relatively large on the side of the first end plate 26a.

One end of a rubber hose 120a is connected to the air intake opening 118a and one end of a rubber hose 120b is connected to the air intake opening 118b. The other end of the rubber hose 120a is connected to a joint 122a and the other end of the rubber hose 120b is connected to a joint 122b. As shown in FIG. 9, the joints 122a, 122b are connected to a vehicle body under cover 124, and opened to the outside. The air intake openings 118a, 118b may be opened directly to the internal space of the front room 18.

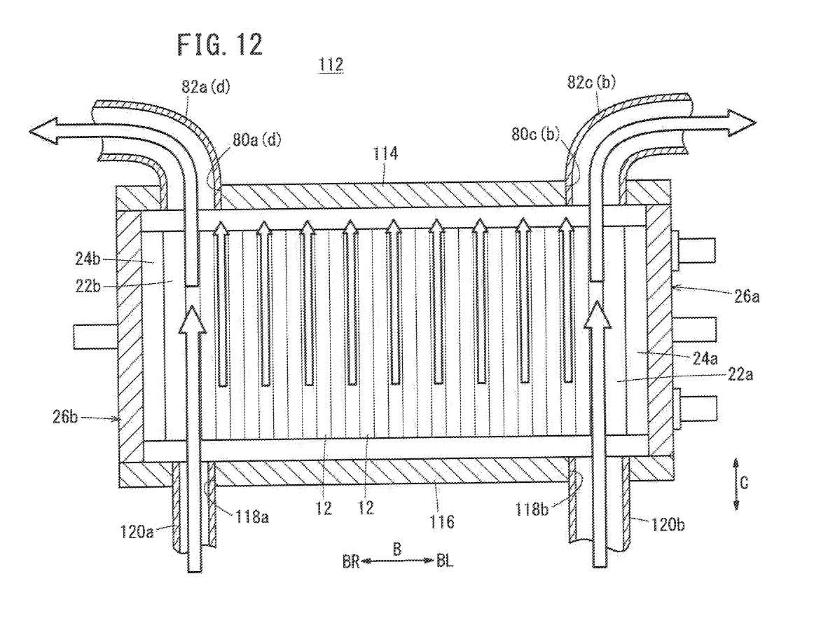

In the third embodiment, as shown in FIG. 12, the external air flows through the rubber hoses 120a, 120b, and the external air is supplied from the air intake openings 118a, 118b into the stack case 112. After the external air flows from the lower side to the upper side in the stack case 112, the external air is released to the outside through the exhaust gas ducts 82a to 82d connected to the openings 80a to 80d.

In the structure, the fuel gas leaked into the stack case 112 flows together with the external air, and the leaked fuel gas can be discharged to the outside further easily and reliably. Further, the air intake openings 118a, 118b are formed in the lower panel 116 on the vehicle front side. In the structure, during traveling of the fuel cell vehicle 110, the external air flowing from the front side to the back side can suitably flow inside the stack case 112. Accordingly, the same advantages as in the cases of the first and second embodiments are obtained. For example, improvement in the performance of discharging the fuel gas is achieved effectively.

In the first to third embodiments, the first end plate 26a and the second end plate 26b are parts forming the stack case 14. However, the present invention is not limited in this respect. For example, the fuel cell stack 12 may be placed in an independent case having a rectangular parallelepiped shape.

While the invention has been particularly shown and described with a reference to preferred embodiments, it will be understood that variations and modifications can be effected thereto by those skilled in the art without departing from the scope of the invention as defined by the appended claims.

What is claimed is:

1. A fuel cell vehicle equipped with a fuel cell stack formed by stacking a plurality of fuel cells in a stacking direction, the fuel cells configured to generate electricity by electrochemical reactions of a fuel gas and an oxygen-containing gas, a fuel gas passage extending through the fuel cells and being configured to allow the fuel gas to flow in the stacking direction, the fuel cell stack being placed in a stack case having a rectangular shape in a plan view, the stack case being mounted in a front room formed in front of a dashboard,
wherein openings are formed at least at one pair of diagonal positions of an upper surface of the stack case, and an internal space of the stack case is connected to outside through the openings.

2. The fuel cell vehicle according to claim 1, the openings are provided at the one pair of diagonal positions and another pair of diagonal positions of the upper surface of the stack case, respectively.

3. The fuel cell vehicle according to claim 1, further comprising a duct member having one end connected to the opening,
wherein an exhaust port is provided at each of both ends of the front room in a vehicle width direction;
the exhaust port is connected to outside of the front room, and positioned above the opening; and
another end of the duct member is connected to the exhaust port.

4. The fuel cell vehicle according to claim 1, wherein an inner upper surface of the stack case facing the fuel cell stack is a flat surface.

5. The fuel cell vehicle according to claim 1, wherein the opening is provided above the fuel gas passage in a vertical direction.

6. The fuel cell vehicle according to claim 1, wherein an air intake opening is formed in a lower surface of the stack case and is configured to allow air to flow into the stack case.

7. The fuel cell vehicle according to claim 6, wherein at least two air intake openings are provided on a vehicle front side of the stack case.

8. The fuel cell vehicle according to claim 7, wherein the air intake openings have different cross sectional areas.

9. The fuel cell vehicle according to claim 8, wherein the cross sectional area of the air intake opening adjacent to a fuel gas manifold connected to the fuel gas passage is larger than cross sectional areas of the other air intake opening.
